(19) United States
(12) Patent Application Publication
(10) Pub. No.: US 2026/0035802 A1
(43) Pub. Date: Feb. 5, 2026

(54) METHOD OF PRE-TREATING METALLIC SUBSTRATES

(71) Applicant: CHEMETALL GMBH, Frankfurt (DE)

(72) Inventors: Daniel SCHATZ, Frankfurt (DE); Denis ERMISCH, New Providence, NJ (US)

(21) Appl. No.: 19/099,502

(22) PCT Filed: Aug. 29, 2023
(86) PCT No.: PCT/EP23/73735

§ 371 Date: Jan. 29, 2025

(30) Foreign Application Priority Data
Aug. 31, 2022 (EP) 22193251.0

(51) Int. Cl. C23G 1/26; C11D 7/26; C23C 22/03; C23C 22/78; C25D 13/20

(52) U.S. Cl. CPC C23G 1/26; C11D 7/265; C23C 22/03; C23C 22/78; C25D 13/20

(57) ABSTRACT

Disclosed herein is a method of pre-treating a metallic substrate, the method including one or more cleaning steps, where at least part of the surface of the metallic substrate is contacted with one or more aqueous cleaning compositions, to obtain a cleaned metallic substrate; and/or one or more chemical pre-treatment steps selected from the group consisting of conversion treating steps, passivation treating steps and thin-layer forming steps, where at least part of the surface of a metallic substrate is contacted with one or more chemical pre-treatment compositions selected from the group consisting of conversion treatment compositions, passivation treatment compositions and thin-layer forming compositions to obtain a chemically pre-treated substrate. Also disclosed herein is a method of coating a metallic substrate, where the first step consists of the method of pre-treating a substrate, where after a last rinsing step one or more coating compositions are applied and cured.

The present invention relates to a method of pre-treating metallic substrates with one or more rinsing compositions subsequently to cleaning and/or conversion coating of the substrates and the use of the rinsing compositions subsequent to cleaning and/or chemical pre-treatment particularly to prevent rust formation. The present invention further relates to a method of coating a metallic substrate, the first steps of the method being the method of pre-treatment according to the invention.

### BACKGROUND

During the production process of metallic sheets, impurities such as mill scale, oxide layers and drawing greases from the deformation process of the sheets arise and have to be removed before any permanent coating layers are applied on the sheet. Furthermore, subsequently to the production of such metallic sheets, which are intended to be coated with one or more coating compositions, oxide layers form rapidly at the surface of the bare sheets. For this reason, the metallic sheets are typically coated with anticorrosive oils by way of temporary anticorrosive protection immediately after manufacture.

Consequently, before applying high-quality coatings on metallic substrates, the substrates have to be thoroughly cleaned to remove the afore-mentioned impurities, oils and greases to avoid the formation of defects in the final coating architecture.

In high-quality coating, the cleaning of sheets is followed by applying a chemical pre-treatment composition such as a conversion treatment composition or thin-layer forming composition to the cleaned metallic sheets forming a conversion coating layer to enhance corrosion protection of such sheets. Such steps are prior to subsequent coating steps such as electrodeposition coating, coating with primer fillers, basecoats and clearcoats or powder coats.

To avoid the contamination of chemical pre-treatment compositions with the cleaning compositions used in the cleaning of the metallic substrates, the metallic substrates are rinsed with one or more rinsing compositions subsequently to the cleaning procedure and before carrying out the conversion coating process. Likewise, excessive chemical pre-treatment composition has to be removed by rinsing the chemically pre-treated substrate before any subsequent coating step such as electrodeposition coating.

It was observed that there is a risk of rust formation, particularly flash rust formation after cleaning and/or chemical pre-treatment in the course of carrying out the rinsing steps and/or shortly after rinsing.

Thus, it was an aim of the present invention to avoid such rust formation during the method of pre-treating a metallic substrate.

In prior art, formulations of rust inhibiting agents are described, where most of the formulations comprising inter alia nitrogen and/or phosphorous containing compounds which are to be avoided because particularly nitrogen in form of toxic nitrite ions is known to have a negative impact on health security and environment and phosphorous containing formulations are also known for their environmental issues.

Nevertheless, many rust inhibiting formulations make use of detrimental amounts of e.g., sodium nitrite or nitric acid, such as proposed in CN 109112515 A, wherein the rust inhibitor is an elaborated composition further comprising acetic, acrylic and stearic acid, polyethylene glycol, quartz sand, sodium (bis) carbonate, sodium benzoate and detergents such as sodium lauryl sulfate and fatty alcohol sulfate, and less than 60 wt.-% of water. Similar compositions are, e.g., disclosed in CN 109112516 A which however contain hydrochloric acid instead of nitric acid, chloride ions actually being known to cause corrosion. Other formulations, e.g., those described in CN 102181854 comprise gluconate, triethanolamine, molybdate, aminophosphonic acids, sodium benzoate and non-ionic surfactants.

Further metal corrosion inhibitors containing significant amounts of phosphoric acid or phosphate, benzoic acid or benzoate, triethanolamine, and at least one selected from mercaptobenzothiazole and its salts, benzotriazole and tolyltriazole are, e.g., known from U.S. Pat. No. 4,219,433 to be used in cooling systems which are in contact with various metallic parts. Another phosphate containing corrosion inhibitor containing sodium hexametaphosphate, N-nitrosophenylhydroxylamine, benzoate, a zinc salt and hexamethylenetetramine is described in CN 103602991 A.

All of the above formulations contain various compounds which can detrimentally affect the coating of a metallic substrate and some of them even contain substances which are to be removed during the cleaning step(s) of the metallic substrate. Thus, the compositions are not apt to be used to prevent flash rust formation occurring during or subsequently to cleaning, rinsing and/or chemically pre-treating metallic substrates.

It is commonly known that organic coating compositions, which are applied subsequent to a prior pre-treatment may contain rust inhibitors. As part of these organic coating compositions, these compounds become permanent part of the cured coating layers and remain in reacted or in free form in the cured coating layer.

However, the present invention aims to employ a flash rust inhibiting function to the pre-treatment steps, prior to further coating steps accomplished with, e.g., primer filler compositions, basecoat compositions and/or clear coat compositions with such function; or with powder coatings.

It was intended to provide measures having the lowest possible impact on formulating subsequent organic coating compositions. Thus, unlike the use as an additive in an organic coating, there should be no need to introduce the corrosion inhibitor directly into such organic coating composition.

Moreover, flash rust formation should already be prevented in the pre-treatment process of metallic substrates, preferably during and after the rinsing steps of the metallic surface pre-treatment.

Therefore, the main aim of the present invention was to provide a method of pre-treating a metallic substrate, wherein the method contains at least one cleaning, rinsing or chemical pre-treatment step making use of a composition which does not contain nitrites which are harmful for health and environment and wherein the composition prevents or inhibits the formation of rust, particularly flash rust, before a subsequent general coating compositions is applied. Furthermore, the compositions, particularly the rinsing compositions should not interfere with any of the subsequent steps such as electrodeposition coating. Moreover, such composition(s) used in the method of pre-treating a metallic substrate should be easily applicable, cost-efficient and easy to produce.

### SUMMARY

It was surprisingly found that the aims of the present invention are achieved by providing a method of pre-treating a metallic substrate, the method comprising
i. one or more pre-treating steps selected from the groups consisting of cleaning steps, wherein at least part of the surface of the metallic substrate is contacted with one or more aqueous cleaning compositions, to obtain a cleaned metallic substrate; and/or, preferably and,
ii. one or more chemical pre-treatment steps selected from conversion treating steps, passivation treating steps and thin-layer forming steps, wherein at least part of the surface of a metallic substrate is contacted with one or more chemical pre-treatment compositions selected from conversion treatment compositions, passivation treatment compositions and thin-layer forming compositions to obtain a chemically pre-treated substrate;
wherein i. and/or ii. are followed by, preferably directly followed, by one or more rinsing steps, wherein at least one composition selected from cleaning compositions, rinsing compositions and chemical pre-treatment compositions comprises an amount of 0.8 to 200 mmol/L of the composition of one or more compounds of formula (I)

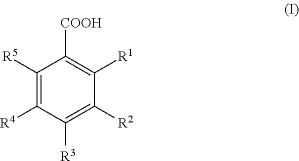

the COOH group of which can be fully or partially neutralized and wherein one or more of residues R¹, R², R³, R⁴ and R⁵ are independently selected from each other from the group consisting of H, hydroxy groups and alkyl groups.

In the following, the afore-mentioned method of pre-treating a metallic substrate and its preferred embodiments is denoted as “method of pre-treating a metallic substrate according to the invention”.

Yet another subject of the present invention is a method of coating a metallic substrate, the method comprising the aforementioned method of pre-treating a metallic substrate according to the invention, wherein after the last rinsing step
iii. one or more coating compositions selected from the group of solid coating compositions and liquid coating compositions are applied to form one or more coating layers, each of the one or more coating layer being cured or not cured after application; and
iv. curing any one or more coating layers applied in step iii. which is or are not cured in step iii.

In the following, the afore-mentioned method of coating a metallic substrate and its preferred embodiments is denoted as “method of coating a metallic substrate according to the invention”.

Further subject matter of the invention is use of an aqueous composition containing an amount of 0.8 to 200 mmol per liter of the composition of an compound of the above formula (I), the COOH group of which can be fully or partially neutralized and wherein one or more of residues R¹, R², R³, R⁴ and R⁵ are independently selected from each other from the group consisting of H, hydroxy groups and alkyl groups, in pre-treating a metallic substrate, the aqueous composition being selected from the group consisting of cleaning compositions, rinsing compositions and chemical pre-treatment compositions.

In the following, the afore-mentioned use and its preferred embodiments are denoted as “use according to the invention”.

In the following section, the invention will be described in more detail.

### DETAILED DESCRIPTION

In the following terms used in the present invention are defined.

The term “pre-treatment” or “pre-treating” as used herein is used in accordance with the term “surface pre-treatment” as defined in Römpp Lexikon “Lacke und Druckfarben” (Publisher: Ulrich Zorll, Editor: Hans-Jürgen P. Adler-Stuttgart; New York: Thieme, 1998; term: “Oberflächenvorbehandlung” page 417).

On metallic substrates, according to DIN 50902:1994-07, the first step of a surface treatment is a layer-removing step, including one or more (chemical) cleaning steps with aqueous or non-aqueous cleaning compositions, and is also called “surface preparation step”.

The term “chemical pre-treatment” is used in accordance with EN ISO 4618:2006 (E/F/D) (term: 2.41 “chemical pre-treatment”, which stands for any chemical process applied to a surface prior to the application of a coating material). According to this standard, e.g., treatments like chromating and phosphating, which belong to conversion treatment, belong to the chemical pre-treatment and thus are to be distinguished from coating steps, wherein coating materials, i.e., coating compositions such as powder coating compositions, electrodeposition coating compositions, aqueous or non-aqueous liquid coating materials are applied.

Besides the typical conversion treatments such as chromating and phosphating, the chemical surface pre-treatment may be achieved with passivation compositions and thin-film forming compositions, which will be described in more detail herein below.

In accordance with the above internationally valid definitions of a “pre-treatment” of metallic substrates, the pre-treatment method according to the present invention encompasses surface preparing cleaning steps and/or chemical pre-treatment steps and in each case at least one rinsing step.

The term “metallic substrate” encompasses, in accordance with the general understanding of said term, any substrate having a surface comprising one or more pure metals and/or alloys. If a substrate comprises areas of different metals, such substrate is herein denoted as “multi-metallic substrate” as a subclass of metallic substrates.

The term “at least part of the metallic substrate” means, in accordance with the general understanding of said term, that in some cases it might be desired or sufficient to contact not the whole surface of the substrate with a cleaning composition, rinsing composition and/or chemical pre-treatment composition. If only part of the metallic surface is contacted with the respective composition, it is typically the same part for all steps of the method. However, generally, it is desired to contact the whole surface of the metallic substrate with the respective composition(s).

The term “contacting the surface of a substrate” encompasses, in accordance with the general understanding of said term, any type of direct contacting.

The term “compositions” means a substance which is composed of one or more ingredients, typically more than one ingredient. However, e.g., a “rinsing composition” may even be composed of water, only.

The term “aqueous” in combination with the term “composition” means that the volatile content of the composition wherein other ingredients might be dissolved or dispersed, predominantly contains or even consists of water. The content of water, based on the total weight of such composition is particularly in case of aqueous rinsing compositions preferably 97 wt.-% to 100 wt.-%, such as 97 wt.-% to 99.99 wt.-%, more preferred 98 wt.-% to 99.99 wt.-%, even more preferred 99 wt.-% to 99.98 wt.-% and most preferred 99.50 to 99.97 wt.-%.

The term “cleaning composition” defines, in accordance with the general understanding of said term, a composition which removes impurities from the surface of the to be further treated metallic substrate, i.e., cleans the metallic substrate, but which does not permanently remain on the surface of the metallic substrate. Thus, the term “cleaning composition” differs from the term “coating composition”, since a coating composition is intended to remain permanently on a substrate.

The term “rinsing composition” defines, in accordance with the general understanding of said term, a composition which removes excessive parts of a composition which was contacted with the metallic surface in the step directly preceding the rinsing step wherein the rinsing composition is used. In the simplest case a rinsing composition can be pure, e.g., de-ionized water.

The term “chemical pre-treatment composition” as used herein encompasses “conversion treatment compositions”, “passivation treatment compositions” and “thin-film forming compositions”.

The term “conversion treatment composition” defines, in accordance with the general understanding of said term, a composition, which, if applied to a substrate metal produces a superficial layer containing a compound of the substrate metal (often referred to as conversion coating) and an anion of an environment (ISO 2080:2008 (E/F), term: 2.3 “conversion treatment”).

### Method of Pre-Treating According to the Invention

The method of pre-treating a metallic substrate according to the present invention provides a method of pre-treating metallic substrates particularly to prevent or inhibit flash rust formation.

The method comprises at least a combination of one or more cleaning steps with one or more subsequent rinsing steps; or at least a combination of one or more chemical pre-treatment steps with one or more subsequent rinsing steps. Thus, herein below, the compounds of formula (I) which can be fully or partially neutralized, and the cleaning steps and the chemical pre-treatment steps will be described first in more detail, and afterwards the one or more rinsing steps will be described, since the rinsing steps are carried out subsequently to the cleaning steps and/or subsequently to the chemical pre-treatment steps in the same manner.

### Compounds of Formula (I)

At least one composition selected from cleaning compositions, rinsing compositions and chemical pre-treatment compositions contains one or more compounds of formula (I)

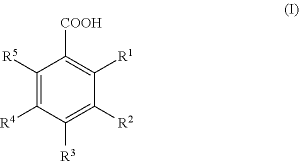

the COOH group of which can be fully or partially neutralized and wherein one or more of residues R¹, R², R³, R⁴ and R⁵ are independently selected from each other from the group consisting of H, hydroxy groups and alkyl groups.

If, in the following, it is referred to compounds of formula (I) the above defined compounds as well as the preferred compounds of formula (I) as described below are to be understood. The amounts and ranges of the amounts specified are likewise valid for the above defined compounds of formula (I) as well as for the preferred compounds of formula (I) as described below.

Depending on the pH value of the cleaning compositions, rinsing compositions and chemical pre-treatment compositions wherein compounds of formula (I) are employed, the COOH group can be fully or partially neutralized. Independently thereof, since the afore-mentioned compositions are typically and preferably aqueous compositions, there is at least some partial dissociation of the COOH group to a COO⁻H⁺ group in equilibrium.

The term “neutralized” encompasses salts of the compounds or formula (I) which are in situ formed due to the pH value of the respective composition, but also salts of the compounds or formula (I) which are formed prior to the incorporation in the respective compositions. Thus, the term “neutralized” includes any commercially available salts of the acidic compound of formula (I), i.e., the COOH carrying compound of formula (I).

The compounds of formula (I), and the fully or partially neutralized compounds of formula (I), as being present in the respective cleaning, rinsing or chemical pre-treatment compositions, preferably possess a water solubility in deionized water at a temperature 20° C., which is at least 0.8 mmol/L Thus, it is preferred that the compounds of formula (I) and the fully or partially neutralized compounds of formula (I) are fully dissolved in the respective compositions at a temperature of 20° C.

Amongst the OH and/or alkyl substituted compounds of formula (I), i.e., the compounds of formula (I) wherein at least one of R¹, R², R³, R⁴ and R⁵ is OH and/or an alkyl group and the corresponding fully or partially neutralized compounds of formula (I), those compounds are preferred, which have not more than 3 groups, selected from OH and alkyl groups.

In case of the alkyl groups, in view of water solubility, it is even more preferred that just 1 or 2 of R¹, of the R², R³, R⁴ and R⁵ groups, most preferred only one of the of R¹, R², R³, R⁴ and R⁵ groups is an alkyl group.

If one or more of R¹, R², R³, R⁴ and R⁵ groups are alkyl groups, it is preferred, in view of water solubility, that the alkyl groups independently of each other have 1 to 3, more preferred 1 or 2 and most preferred only 1 carbon atom.

Most preferred all of the R¹, R², R³, R⁴ and R⁵ groups are hydrogen. In such case the compound of formula (I) is benzoic acid. Neutralized benzoic acids are particularly their salts, preferably their water-soluble salts.

Particularly preferred neutralized species of the compounds of formula (I) are the alkali metal salts, ammonium salts and quaternary ammonium salts thereof.

Most preferred are the sodium, potassium, ammonium and tetramethyl ammonium salts of the compounds of formula (I), particularly preferred the afore-mentioned salts of benzoic acid.

The i. Cleaning Step(s)

In a first aspect of the method of pre-treating according to the invention a metallic substrate, is subjected to i. one or more cleaning steps, typically i. two or more cleaning steps, wherein at least part of the surface or preferably the complete surface of the metallic substrate is contacted with one or more cleaning compositions at least one of which is an aqueous cleaning composition, to obtain a cleaned metallic substrate. Preferably, if more than one cleaning composition is used, all cleaning compositions used are aqueous cleaning compositions.

Metallic substrates to be used in the coatings industry often contain impurities on their surfaces which may be attached physically or chemically on the metallic surface of the metallic substrate. Such impurities are amongst others oils and greases used in the production and customizing of the metallic substrates or oxidation products such as oxides and/or hydroxides of the metals present in the metallic surface of the metallic substrate. The presence of such impurities typically leads to defects in subsequently formed chemical pre-treatment layers and coating layers. Such defects may, e.g., cause a decreased adhesion of the coating layers to the metallic substrate surface. Therefore, it is indispensable to clean contaminated metallic substrates before further use.

The term metallic substrate as used herein includes substrates of any shape, such as flat metallic substrates like simple panels or coils, but also metallic substrates with complex shapes like automotive bodies or parts thereof. The term “metallic” as used herein comprises pure metals and metal alloys as explained above. Particularly preferred examples of metals and alloys are cold-rolled steel, galvanized steel such as hot-dip galvanized steel or electrolytically galvanized steel and aluminum and its alloys. Particularly preferred substrates are cold-rolled steel and galvanized steel, such as hot-dip galvanized steel. Moreover, the term “substrate” also comprises pre-assembled metal parts, the metal parts being of the same metal or alloy or the metal parts being of at least two different metals or alloys (multi-metal capability of the method).

The i. one or more steps of contacting the metallic substrate with a cleaning composition can be carried out by any common cleaning procedure. Most preferred are spray cleaning and/or dip cleaning. The temperature of the cleaning composition used in the one or more i. cleaning steps is preferably in the range from 20 to 70° C., more preferred 30 to 65° C. and most preferred 40 to 60° C. such as 45 to 60° C. The duration of contacting the metallic substrate with the cleaning composition preferably ranges from 0.5 min to 15 min, more preferred 1 min to 10 min, most preferred 2 to 5 min.

### Cleaning Compositions

In principle all kinds of commonly used cleaning compositions can be used in the one or more cleaning steps in the method of pre-treating according to the present invention, dependent on the type of impurities to be removed and the metal or alloy the substrate comprises or consists of.

The cleaning compositions are preferably aqueous and have preferably a pH value at 20° C. in the range from 3.5 to 12.5. Cleaning compositions having a pH value at 20° C. in the range from 3.5 to below 6 are commonly denoted as acidic cleaning compositions, while cleaning compositions having a pH value at 20° C. in the range from 6 to 8 are denoted as being neutral and those cleaning compositions having a pH value at 20° C. in the range of more than 8 to 12.5 are denoted as alkaline cleaning compositions. The cleaning compositions, independent of their acidic, neutral or alkaline pH values, do preferably not contain nitrates or nitric acid and even more preferred the cleaning compositions do not contain nitrates, nitric acid and phosphorous containing ingredients.

Preferred acidic cleaning compositions have a pH value in the above-mentioned range and contain one or more ingredients selected from the groups consisting of inorganic acids such as sulfuric acid, organic acids, complexing agents, surfactants and fluorides.

Preferred neutral cleaning compositions have a pH value in the above-mentioned range and contain one or more ingredients selected from the group consisting of pH adjusting agents, alkanolamines, caustic, surfactants and complexing agents.

Preferred alkaline cleaning compositions have a pH value in the range from 8 to 12.5, more preferred 9 to 11, such as 10 to 11. Preferably alkaline cleaning compositions comprise one or more ingredients selected from the group consisting of pH adjusting agents, caustic, surfactants and complexing agents.

Suitable cleaning compositions and/or their water-dilutable concentrates are for example commercially available from Chemetall GmbH (Frankfurt, Germany) under the tradename Gardoclean®.

Since the typical ingredients of cleaning compositions and often their rather extreme pH values negatively interfere with subsequent steps such as chemical pre-treatment, the cleaning step(s) are preferably directly followed by one or more rinsing steps. The one or more rinsing steps which follow the one or more cleaning steps and the rinsing compositions used therein will be described below under the headline “Rinsing Steps” below.

According to the method of the invention at least one of the cleaning compositions, or if just one cleaning composition is used, the one cleaning composition can be supplemented with an amount of 0.8 to 200 mmol per liter of the composition, preferably 1.0 to 150 mmol per liter of the composition, more preferred 1.2 to 120 mmol per liter of the composition, and even further preferred 1.6 to 50 mmol per liter of the composition, of one or more compounds of the above formula (I) wherein the COOH group can be fully or partially neutralized and wherein one or more of residues R¹, R², R³, R⁴ and R⁵ are independently selected from each other from the group consisting of H, hydroxy groups and alkyl groups, in order to prevent or inhibit the formation of rust, particularly flash rust during and subsequent to the cleaning procedure.

The ii. Chemical Pre-treatment Step(s)

In a second aspect of the method of pre-treating according to the invention a metallic substrate, is subjected to ii. one or more chemical pre-treatment steps, preferably ii. one pre-treatment step, wherein at least part of the surface or the complete surface of the metallic substrate is contacted with one or more chemical pre-treatment compositions to obtain a chemically pre-treated metallic substrate. The metallic substrates used in the chemical pre-treatment step(s) are the same as defined as in the cleaning step(s).

The ii. one or more steps of contacting the metallic substrate with a chemical pre-treatment composition can be carried out by any common conversion treatment procedure, passivation treatment procedure and/or thin-film forming procedure. Most preferred are spray application and/or dip application, the latter one being most preferred. The duration of contacting the metallic substrate with the chemical pre-treatment composition preferably ranges from 15 seconds to 8 min, more preferred 1 min to 5 min, most preferred 2 min to 4 min.

Generally, the temperature of the chemical pre-treatment composition used in the ii. one or more chemical pre-treatment steps is preferably in the range from 10 to 60° C., more preferred 15 to 55° C., even more preferred 20 to 50° C.

Within the afore-mentioned ranges, in case the chemical pre-treatment is a thin-film formation, the temperatures preferably range from 10 to 50° C., more preferred 15 to 45° C. and most preferred 20 to 40° C. such as 25 to 35° C. Using other chemical pre-treatment compositions such as zinc phosphate-based compositions the temperature is preferably in the range from 20 to 60° C., and most preferred 30 to 55° C. such as 35 to 50° C.

### Chemical Pre-treatment Compositions

Generally, any known chemical pre-treatment composition as used in metal surface finishing can be used in the ii. one or more chemical pre-treatment steps of the method of pre-treating a metallic substrate according to the present invention.

The chemical pre-treatment compositions used in the present invention are preferably acidic chemical pre-treatment compositions.

Preferably the chemical pre-treatment compositions used in the method for coating according to the present invention are selected from
a. phosphate conversion treatment compositions, including compositions which are layer-forming and non-layer-forming. Examples for phosphate conversion treatment compositions are
   i. Ni-containing and Ni-free zinc phosphating compositions and trication phosphating compositions, i.e, so-called “layer forming systems”
   ii. compositions forming amorphous phosphate conversion coatings, i.e., so called non-layer forming systems,
   iii. phosphate conversion treatment compositions containing zinc ions and at least one of manganese ions and nickel ions including Ti/Zn based activation and optional zirconium-based passivation; and
   iv. compositions forming amorphous iron phosphate conversion coatings,
b. organosilane based thin-film forming compositions containing at least one organosilane and/or its hydrolysis products and/or its condensation products; and
c. passivating compositions containing at least one compound selected from the groups of zirconium compounds, titanium compounds and hafnium compounds.
d. passivating and thin-film forming compositions containing at least one compound selected from the groups of zirconium compounds, titanium compounds and hafnium compounds and containing at least one organosilane and/or its hydrolysis products and/or its condensation products;
e. passivating compositions containing at least one compound selected from the groups of zirconium compounds, titanium compounds and hafnium compounds and containing one or more polymers selected from the group consisting of poly(vinyl phenol)s, poly(meth)acrylic acid, (meth)acrylic acid copolymers, maleic acid copolymers, phosphonic acid copolymers, particularly (phosphonic acid-acrylic acid) copolymers, polyvinyl pyrrolidone and vinyl pyrrolidone copolymers, vinyl acetate copolymers, particularly (vinyl alcohol-vinyl acetate) copolymers, ethoxylated polymers e.g. polyethylene glycol and copolymers, and linear or branched poly(ethylene imines).

If a phosphate conversion treatment step, particularly a zinc phosphating step or a trication phosphating step is carried out in ii., it is preferred to carry out an additional activation step prior to ii. If carried out, the activation step is carried out by contacting the metallic substrate prior to step ii. with an activation composition. Contacting is preferably carried out by dipping or spraying. Most preferred is contacting the metallic substrate by dip application of the activation composition. The duration of the contacting step with the activation composition preferably ranges from 5 to 300 seconds, more preferred 10 to 200 seconds and most preferred 20 to 90 seconds such as 30 to 60 seconds. Activation compositions or solutions are for example available from Chemetall GmbH (Frankfurt, Germany) under the trademark Gardolene® V. If an activation step is carried out, the activation composition used therein preferably contains zinc phosphate crystals and/or titanium phosphate crystals, which facilitate the deposition of the phosphate conversion layer.

Amongst the zinc phosphating compositions, Ni-containing compositions may be employed. However, for environmental reasons, Ni-free zinc phosphating conversion treatment compositions are preferred, which contain Zn ions and Mn ions. Further variants of zinc phosphating conversion treatment compositions are the so-called trication phosphate conversion treatment compositions containing Zn, Mn and Ni ions. Phosphate conversion treatment compositions are for example available from Chemetall GmbH (Frankfurt, Germany) under the trademark Gardobond® R for Zinc phosphating and Gardobond A for amorphous phosphate products.

Organosilane-based thin-film forming compositions preferably contain at least one organosilane, such as an amino silane, the term “organosilane” including its hydrolysis products and condensation products, and optionally compounds selected from the group of zirconium compounds, titanium compounds and hafnium compounds. Such compositions are for example available from Chemetall GmbH (Frankfurt, Germany) under the trademark Oxsilan®, such as Oxsilan® 9831, Oxsilan® 9832, Oxsilan 9810/1 and Oxsilan 9810/3 to produce thin-film layers.

Passivation treatment compositions preferably contain at least one compound selected from the groups of zirconium compounds, titanium compounds and hafnium compounds, more preferably a fluoro complex of titanium, zirconium and/or hafnium. Such passivation treatment compositions optionally contain one or more organosilanes the term “organosilane” including its hydrolysis products and condensation products.

An example of a passivation treatment compositions containing at least one compound selected from the groups of zirconium compounds, titanium compounds and hafnium compounds and containing one or more polymers is, e.g., Gardobond® GBX 2025/2. Generally, any layers formed in the chemical pre-treatment step(s) have a thickness of typically less than 2 μm, such as preferably 50 nm to 2000 nm, more preferred 500 to 1500 nm for phosphate conversion treatment, such as iron- and zinc phosphating and preferably 20 nm to 300 nm, more preferred 30 to 200 nm for thin film forming pre-treatment.

According to the method of the invention one or more chemical pre-treatment compositions, or if just one chemical pre-treatment composition is used, the one chemical pre-treatment composition can be supplemented with an amount of 0.8 to 200 mmol per liter of the composition, preferably 1.0 to 150 mmol per liter of the composition, more preferred 1.2 to 120 mmol per liter of the composition, and even further preferred 1.6 to 50 mmol per liter of the composition, of one or more compounds of the above formula (I) wherein the COOH group can be fully or partially neutralized and wherein one or more of residues R¹, R², R³, R⁴ and R⁵ are independently selected from each other from the group consisting of H, hydroxy groups and alkyl groups, in order to prevent or inhibit the formation of rust, particularly flash rust during and subsequent to the cleaning procedure.

### Rinsing Step(s)

The one or more rinsing steps, preferably at least two rinsing steps, are carried out to remove excessive cleaning composition left on the surface of the metallic substrate after carrying out the i. one or more cleaning steps; and/or to remove excessive chemical pre-treatment composition left on the surface of the chemically pre-treated metallic substrate after carrying out the ii. one or more chemically pre-treatment steps.

The rinsing steps are preferably carried out by spray or dip application, preferably dip application of the respective rinsing compositions.

In principle, in both cases i. and ii., it is preferred to rinse the cleaned and/or chemically pre-treated substrates with tap water and/or deionized water, to avoid introducing undesired substances.

However, if neither one of the i. one or more cleaning compositions nor one of the ii. one or more chemical pre-treatment compositions makes use of a respective composition supplemented with the above identified amounts of the one or more compounds of formula (I), the COOH groups of which may be partially or fully neutralized as defined above, it has been observed in many cases that the cleaned and/or chemically pre-treated metallic substrates tend to form rust, particularly flash rust on their surfaces, if only water is used as rinsing composition. However, such rust formation or flash rust formation is generally detrimental for the formation of further coating layers on the substrate and leads to defects, which again cause a decreased adhesion of further coating layers and/or a decreased corrosion protection.

### Rinsing Composition(s)

As explained above, the rinsing compositions as used in the rinsing steps can be carried out with water or water containing drag over from the previous step(s) of the method of pre-treating according to the invention, if at least one of the used cleaning compositions and/or chemical pre-treatment compositions contains the respective amounts of the one or more compounds of formula (I), the COOH groups of which may be partially or fully neutralized as defined above. If more than one rinsing step is carried out, the first rinsing step is preferably carried out with tap water as rinsing composition.

If spray applied and tap water is used as the first rinsing composition in the first rinsing step, such water such as tap water preferably having a conductivity of 200 to 3500 μS/cm², preferably 200 to 2500 μS/cm². Of course, water having a lower conductivity such as deionized water can also be used in the first rinsing step as rinsing composition. Thus, the rinsing composition can be composed of pure water only. Conductivity is measured with commercially available conductivity measurement device (WTW pH/Cond 340i; calibrated in a solution of potassium chloride with a conductivity of 1.413 mS/cm at 25° C.).

If the first rinsing composition is dip applied, the same rinsing compositions as used in spray application can be used. However, if the metallic substrates are rinsed in a continuous process, the rinsing composition in the dip tank will further contain diluted ingredients of the previous pre-treatment step dragged into the dip tank from the previously rinsed metallic substrates (sheets), i.e., ingredients from the cleaning step(s) or the chemical pre-treatment step(s).

If the first rinsing composition is used for dip-rinsing it typically has a pH value in the range from 6 to 10 due to drag-over from the previous cleaning composition and/or chemical pre-treatment composition and thus contains all ingredients of the cleaning composition and/or the chemical pre-treatment composition, in a highly diluted form to preferably fulfill the above-mentioned conductivity range. Of course, the first rinsing step can also be carried out with de-ionized water, too.

The second rinsing composition preferably also has a pH value in the range from 6 to 10, more preferred from 6.5 to 9 due to the drag-over from the first rinsing compositions and again contains all ingredients of the first rinsing composition, but further water-diluted. Of course, the second rinsing step can also be carried out with de-ionized water, too.

Thus, from rinsing step to rinsing step the drag-over will contain less of the ingredients contained in the cleaning compositions and/or chemical pre-treatment compositions.

Preferably, the last rinsing step (can be the first rinsing step if just one rinsing step is carried out, but can also be the second or any further rinsing step) of the rinsing steps carried out subsequent to the cleaning step(s) and/or the chemical pre-treatment step(s) is carried out by use of water having a conductivity of less than 500 μS/cm², such 5 to 500 μS/cm², more preferred 0 to 200 μS/cm². Of course, the last rinsing step can also be carried out with de-ionized water, too.

### Rinsing Composition Comprising a Corrosion Inhibitor

According to the present invention, if neither one of the i. one or more cleaning compositions nor one of the ii. one or more chemical pre-treatment compositions, if used, makes use of a composition supplemented with the above identified amounts of benzoic acid and/or its above-mentioned salts, it becomes necessary that at least one of the rinsing compositions used subsequently to the cleaning step(s) and/or one of the rinsing compositions used subsequently to the chemical pre-treatment step(s) comprises an amount of 0.8 to 200 mmol per liter of the composition, preferably 1.0 to 150 mmol per liter of the composition, more preferred 1.2 to 120 mmol per liter of the composition, and even further preferred 1.6 to 50 mmol per liter of the composition, of one or more compounds of the above formula (I), wherein the COOH group can be fully or partially neutralized and wherein one or more of residues R¹, R², R³, R⁴ and R⁵ are independently selected from each other from the group consisting of H, hydroxy groups and alkyl groups. Most preferred the upper limits of the afore-mentioned ranges being 34, 32, 30, 28, 26, 24 or 22 mmol of one or more compounds of the above formula (I), wherein the COOH group can be fully or partially neutralized and wherein one or more of residues R¹, R², R³, R⁴ and R⁵ are independently selected from each other from the group consisting of H, hydroxy groups, and alkyl groups, per liter of the rinsing composition.

Besides water and some possible drag-over from preceding cleaning and/or chemical pre-treatment steps and the above amounts of the of one or more compounds of the above formula (I), wherein the COOH group can be fully or partially neutralized, and optionally pH adjusting agents, the rinsing composition is preferably not supplemented with any further ingredients.

However, if further ingredients are contained, the main ingredient, except for pH adjusting agents, contained in the rinsing composition comprising the corrosion inhibitor are besides water, preferably the of one or more compounds of the above formula (I), wherein the COOH group can be fully or partially neutralized. As neutralized compound of formula (I), preferably benzoic acid is used in neutralized form, such as sodium benzoate or potassium benzoate.

The preferred pH value range of the rinsing composition comprising the corrosion inhibitor is from 5 to 12, more preferred from 6 to 11 and most preferred from 7 to 10.

Most preferred there are no nitrite and/or phosphorus containing substances intentionally employed in the rinsing composition comprising the corrosion inhibitor as used in the method of pre-treatment of a metallic substrate according to the invention. However, if such substances are contained in the cleaning and/or chemical pre-treatment compositions, it might happen that due to some drag-over, trace amounts of such substances are transferred into the rinsing compositions used in the rinsing steps.

Typically, the amount of nitrite, if contained at all in the rinsing composition comprising the one or more compounds of the above formula (I), wherein the COOH group can be fully or partially neutralized, is less than 0.1 wt.-%, more preferred less than 0.01 wt.-% and most preferred 0 wt.-%. Typically, the amount of phosphorous containing substances, if contained at all in the rinsing composition comprising one or more compounds of the above formula (I), wherein the COOH group can be fully or partially neutralized is less than 0.1 wt.-%, more preferred less than 0.01 wt.-% and most preferred 0 wt.-%.

It was highly surprising that the afore-mentioned one or more compounds of the above formula (I), wherein the COOH group can be fully or partially neutralized, act as effective flash rust inhibitors in rinsing solutions and that they work particularly in such small amounts. It was surprising that highly diluted solutions of such compounds, which typically do not form permanent coatings are useful in the prevention of flash rust. The same is true for the cleaning compositions which are also not thought to stay permanently on the metallic substrate, but also for layers formed by chemical pre-treatment, which have a very low, if at all, capacity to entrap one or more compounds of the above formula (I), wherein the COOH group can be fully or partially neutralized.

### Preferred Sequences of Steps of the Method of Pre-Treating Metallic Substrates

It is preferred (embodiment A) that the method of pre-treating a metallic substrate according to the invention comprises
i. one or more pre-treating steps selected from the groups consisting of cleaning steps, wherein at least part of the surface of the metallic substrate is contacted with one or more aqueous cleaning compositions, to obtain a cleaned metallic substrate; followed by
ii. one or more chemical pre-treatment steps selected from conversion treating steps, passivation treating steps and thin-layer forming steps, wherein at least part of the surface of a metallic substrate is contacted with one or more chemical pre-treatment compositions selected from conversion treatment compositions, passivation treatment compositions and thin-layer forming compositions to obtain a chemically pre-treated substrate,
wherein i. and ii. are followed by one or more rinsing steps, wherein at least one composition selected from cleaning compositions, rinsing compositions and chemical pre-treatment compositions comprises an amount of 0.8 to 200 mmol/L of the composition of one or more compounds of formula (I) as defined above, wherein the COOH group of which can be fully or partially neutralized.

It is further preferred (embodiment B) that the method of pre-treating a metallic substrate according to the invention comprises
i. one or more pre-treating steps selected from the groups consisting of cleaning steps, wherein at least part of the surface of the metallic substrate is contacted with one or more aqueous cleaning compositions, to obtain a cleaned metallic substrate; followed by one or more activation steps, followed by
ii. one or more chemical pre-treatment steps selected from phosphate conversion treating steps, wherein at least part of the surface of a metallic substrate is contacted with one or more chemical pre-treatment compositions selected from phosphate conversion treatment compositions, to obtain a chemically pre-treated substrate,
wherein i. and ii. are followed by one or more rinsing steps, wherein at least one composition selected from cleaning compositions, rinsing compositions and chemical pre-treatment compositions comprises an amount of 0.8 to 200 mmol/L of the composition of one or more compounds of formula (I) as defined above, wherein the COOH group of which can be fully or partially neutralized.

Alternatively, it is further preferred (embodiment C) that the method of pre-treating a metallic substrate according to the invention comprises
i. one or more pre-treating steps selected from the groups consisting of cleaning steps, wherein at least part of the surface of the metallic substrate is contacted with one or more aqueous cleaning compositions, to obtain a cleaned metallic substrate; directly followed by
ii. one or more phosphate-free chemical pre-treatment steps to obtain a chemically pre-treated substrate,
wherein i. and ii. are followed by one or more rinsing steps, wherein at least one composition selected from cleaning compositions, rinsing compositions and chemical pre-treatment compositions comprises an amount of 0.8 to 200 mmol/L of the composition of one or more compounds of formula (I) as defined above, wherein the COOH group of which can be fully or partially neutralized.

For any of the above embodiments A to C, it is further preferred that at least one of the cleaning or rinsing compositions, preferably one of the rinsing compositions contains the above-mentioned amounts of the above-mentioned one or more compounds of the above formula (I), wherein the COOH group can be fully or partially neutralized.

Even more preferred for any of the above embodiments A to C, at least one of the rinsing compositions following the one or last cleaning step, preferably the last rinsing composition following the one or last cleaning step before carrying out the activation step(s) in embodiment B or the chemical pre-treatment step(s) in embodiments A to C and/or at least one of the rinsing compositions following the chemical pre-treatment step, preferably the last rinsing composition following the chemical pre-treatment step(s), contains the above-mentioned amounts of the above-mentioned one or more compounds of the above formula (I), wherein the COOH group can be fully or partially neutralized.

In any of the afore-mentioned embodiments A to C, it is preferred that the above-mentioned general or preferred amounts of the above-mentioned one or more compounds of the above formula (I), wherein the COOH group can be fully or partially neutralized are only contained in the rinsing compositions, preferably only in the last rinsing compositions and most preferred only the last rinsing composition following the cleaning step and optionally the last rinsing composition following the chemical pre-treatment step.

It is optional to dry the metallic substrate after carrying out the one or more rinsing steps. If the method of pre-treating a metallic substrate is carried out directly prior to powder coating or coating with an aqueous coating composition or solvent-based coating composition it is preferred to first dry the pre-treated metallic substrate after the last rinsing step. However, if electrodeposition coating follows the last rinsing step, it is typically not necessary to dry the pre-treated metallic substrate prior to electrodeposition coating, because it is typically carried out as aqueous dip-coating.

### Method of Coating a Metallic Substrate

In the method of coating a metallic substrate, first the method of pre-treating a metallic substrate according to the present invention is carried out, followed by applying one or more coating compositions selected from the group solid coating compositions and liquid coating compositions to form one or more coating layers, herein also referred to as paint coating layers in contrast to any layers that might be formed in the chemical pre-treatment step(s). Furthermore, curing of the one or more coating compositions is carried out.

Thus, a further subject of the present invention is a method of coating a metallic substrate, the method comprising
i. one or more pre-treating steps selected from the groups consisting of cleaning steps, wherein at least part of the surface of the metallic substrate is contacted with one or more aqueous cleaning compositions, to obtain a cleaned metallic substrate; and/or, preferably and,
ii. one or more chemical pre-treatment steps selected from conversion treating steps, passivation treating steps and thin-layer forming steps, wherein at least part of the surface of a metallic substrate is contacted with one or more chemical pre-treatment compositions selected from conversion treatment compositions, passivation treatment compositions and thin-layer forming compositions to obtain a chemically pre-treated substrate;
wherein i. and/or ii. are directly followed by one or more rinsing steps, wherein at least one composition selected from cleaning compositions, rinsing compositions and chemical pre-treatment compositions comprises an of 0.8 to 200 mmol per liter of the composition, preferably 1.0 to 150 mmol per liter of the composition, more preferred 1.2 to 120 mmol per liter of the composition, and even further preferred 1.6 to 50 mmol per liter of the composition, of one or more compounds of the above formula (I), wherein the COOH group can be fully or partially neutralized and wherein one or more of residues R¹, R², R³, R⁴ and R⁵ are independently selected from each other from the group consisting of H, hydroxy groups and alkyl groups, wherein after the last rinsing step
iii. one or more coating compositions selected from the group of solid coating compositions and liquid coating compositions are applied to form one or more coating layers, each of the one or more coating layer being cured or not cured after application; and
iv. curing any one or more coating layers applied in step iii. which is or are not cured in step iii.

The solid coating compositions are preferably powder coating compositions most preferably selected from the groups consisting of thermosetting resins. Preferably, the powder coatings are selected from, but not limited to the group of resins consisting of epoxy resins, mixtures of epoxy resins with polyester resins, mixtures of polyester resins with isocyanate components, poly(meth)acrylates and mixtures of polyesters with triglycidylisocyanurates.

The liquid coating compositions can be one-pack or two-pack coating compositions, aqueous or non-aqueous coating compositions. The non-aqueous coating compositions can be solvent-borne coating compositions or preferably solvent-free radiation curing coating compositions.

Particularly in automotive OEM coating the following coating steps are carried out in the order of applying an electrodeposition coating composition, applying one or more primer filler compositions, applying one or more basecoat compositions and applying one or more clear coat compositions and curing the coatings layers formed.

Thus, a further subject of the present invention is a method of coating a metallic substrate, the method comprising
i. one or more cleaning steps, wherein at least part of the surface of the metallic substrate is contacted with one or more aqueous cleaning compositions, to obtain a cleaned metallic substrate; and/or
ii. one or more chemical pre-treatment steps, wherein at least part of the surface of a metallic substrate is contacted with one or more chemical pre-treatment compositions to obtain a chemically pre-treated substrate;
wherein i. and/or ii. are directly followed by one or more rinsing steps, wherein at least one composition selected from cleaning compositions, rinsing compositions and chemical pre-treatment compositions comprises an of 0.8 to 200 mmol per liter of the composition, preferably 1.0 to 150 mmol per liter of the composition, more preferred 1.2 to 120 mmol per liter of the composition, and even further preferred 1.6 to 50 mmol per liter of the composition, of one or more compounds of the above formula (I), wherein the COOH group can be fully or partially neutralized and wherein one or more of residues R¹, R², R³, R⁴ and R⁵ are independently selected from each other from the group consisting of H, hydroxy groups and alkyl groups, wherein after the last rinsing step
iii. one or more of the following coating steps are carried out to form one or more coating layers by applying an electrodeposition coating composition, applying one or more primer filler compositions, applying one or more basecoat compositions and applying one or more clear coat compositions and curing or not curing the thus formed coating layer(s), and
iv. curing any one or more coating compositions which were not yet cured in step iii.

Any of the preferred features and embodiments described above in connection with the method of treating a metallic substrate are also preferred features and embodiments of the method of coating a metallic substrate and are therefore not explicitly repeated herein below.

The iii. Coating Step(s)

Subsequently to the method of pre-treatment according to the invention and particularly subsequently to any of the methods embodiments A to C as described above, particularly in automotive OEM coating, an electrodeposition coating composition is preferably applied onto the only or last chemical pre-treatment layer.

Electrodeposition coating compositions are aqueous coating compositions which are applied by dip coating, i.e., dipping the pickled, chemically pre-treated metallic substrate into the electrically conductive, aqueous electrodeposition coating composition and applying a direct voltage between the substrate and a counter electrode. The electrodeposition coating composition is an anodic or cathodic electrodeposition coating composition, preferably a cathodic electrodeposition coating composition. Cathodic electrodeposition coating compositions are preferably selected from epoxy type and poly(meth)acrylate-type electrodeposition coating compositions. They are applied according to the coating manufacturers specifications.

Subsequently to forming the electrodeposition coating layer the thus formed layer is preferably rinsed and cured according to the paint manufacturers specifications.

Subsequent to the electrodeposition coating step it is preferred to apply one or more further coating compositions. Such further coating compositions are preferably selected from water-based coating compositions, solvent-borne coating compositions or UV-curing coating compositions. However, so-called powder coating compositions can also be applied. Particularly preferred at least one of a primer filler coating composition, a basecoat composition and a clear coat composition is applied, most preferably in this order. If a plurality of coating layers is formed (i.e., at least two coating compositions are applied), the application can be carried out wet-in-wet and afterwards the coating layers can be cured simultaneously. However, it is also possible to carry out drying steps and/or curing steps between the application of at least some or all of the plurality of coating compositions.

Alternatively, with or without applying an electrodeposition coating composition, a single powder coating compositions or a single aqueous or a single non-aqueous coating composition can be applied. Particularly, if a powder coating composition is applied, it is advisable to first dry the rinsed and/or electrodeposition coated substrate.

The iv. Curing of the iii. One or More Coatings

The conditions of the curing step depend on the coating compositions applied subsequent to the method of pre-treating the metallic substrate according to the invention.

The term “curing” as used herein encompasses any type of curing, preferably physically drying, radiation curing, and thermally curing, wherein thermal curing preferably encompasses any curing mechanism by chemical crosslinking other than radiation curing. E.g., the term thermal cure includes the cure of 1-pack compositions and 2-pack compositions. One-pack compositions typically curing at temperatures above 100° C., e.g., in the range from 120 to 200° C., while two-pack compositions typically start curing at room temperature such as temperatures from 20° C. to 100° C. and are thus typically not storage-stable under ambient conditions.

The method of coating metallic substrates according to the invention provides good adherence of the coatings and corrosion-resistance to the metallic substrate.

### Use According to the Invention

Further subject matter of the invention is use of an aqueous composition containing an amount of 0.8 to 200 mmol per liter of the composition, preferably 1.0 to 150 mmol per liter of the composition, more preferred 1.2 to 120 mmol per liter of the composition, and even further preferred 1.6 to 50 mmol per liter of the composition, of one or more compounds of the above formula (I), wherein the COOH group can be fully or partially neutralized and wherein one or more of residues R¹, R², R³, R⁴ and R⁵ are independently selected from each other from the group consisting of H, hydroxy groups and alkyl groups, in pre-treating a metallic substrate, the pre-treatment comprising at least one of a cleaning step and a chemically pre-treatment step; and in addition at least one rinsing step. Preferably, the aqueous composition is selected from the group consisting of cleaning compositions, rinsing compositions and chemical pre-treatment compositions, preferably from cleaning compositions and rinsing compositions and most preferred the aqueous composition is a rinsing composition.

The use according to the invention provides for a prevention or inhibition of rust formation, particularly flash rust formation on the metallic substrate.

In the following the invention will be further explained by providing working examples.

### Examples

### Testing of Cleaned and Rinsed Subtrates

### Flash Rust Formation Testing (FRF Test)

Flash rust lab scale simulation of steel panels as substrates was simulated according to two procedures. In procedure 1 it was made use of sodium chloride as a flash rust formation promoter, while in procedure 2 humidity exposure was applied to promote flash rust formation.

### Procedure 1

In this procedure, cold rolled steel panels (CRS panels) were
(a) cleaned with 20 g/L GC S 5411®/3 g/L GBA 7400, an alkaline builder and organic surfactant, which is a typical cleaner product provided by Chemetall GmbH, for 180 seconds at 60° C. in a dip application;
(b) after this cleaning step, the panels were rinsed in a first with tap water for 15 seconds;
(c) after the first rinse a second dip rinse was carried out with deionized water for 10 seconds; the deionized water being supplemented before use with: 200 ppm sodium chloride and no inhibitor (Control 1); or 200 ppm sodium chloride and 40 mg/L of sodium nitrite (Comparative Example 1); or 200 ppm sodium chloride and 500 mg/L (equals≈3.5 mmol/L) of sodium benzoate (Example A); or 200 ppm sodium chloride and 3000 mg/L (equals≈20.8 mmol/L) of sodium benzoate (Example B);
(d) after the second rinse the thus treated substrate was air-dried.

Rust formation was evaluated visually (brown stain due to flash rust formation).

Amount and intensity of flash rust formation was evaluated visually and divided in 3 categories (inhibition (no visible flash rust), partially inhibited (better than “control 1 or 2” but still a few rust spots visible) and no inhibition (no difference to “control 1 or 2”).

Furthermore procedure 1 was repeated with different amounts of sodium benzoate in the second rinse od step (c), namely 0.1 g/L (equals≈0.7 mmol/L), 0.2 g/L (equals≈1.4 mmol/L), 0.3 g/L (equals≈2.1 mmol/L), 0.5 g/L (equals≈3.5 mmol/L) and 3 g/L (equals≈20.8 mmol/L) of sodium benzoate in deionized water supplemented with 200 ppm sodium chloride in each case. Results are shown in Table 1 of the results section below.

### Procedure 2

In this procedure, cold rolled steel panels (size: 105 mm×95 mm×0.8 mm) were
(a) cleaned as in procedure 1;
(b) rinsed with a first dip rinse as in procedure 1;
(c) after the first rinse a second dip rinse was carried out with deionized water for 10 seconds; the deionized water being supplemented before use with: nothing (Control 2); or 40 mg/L of sodium nitrite (Comparative Example 2); or 500 mg/L (equals≈3.5 mmol/L) of sodium benzoate (Example C); or 3000 mg/L (equals≈20.8 mmol/L) of sodium benzoate (Example D);
(d) after the second rinse, the thus treated panel was hung centered and vertically oriented in a closed cylindric container (diameter: 125 mm; height: 280 mm) the lowest of the four edges of the panel being in a distance of approx. 1 cm above the surface of the tempered tap water for 600 seconds to simulate high humidity;
(e) after step (d) the substrate was dried by using compressed air.

Rust formation was evaluated visually (brown stain due to flash rust formation) as described above for procedure 1.

Furthermore procedure 2 was repeated with different amounts of sodium benzoate in the second rinse od step (c), namely 0.1 g/L (equals≈0.7 mmol/L), 0.2 g/L (equals≈1.4 mmol/L), 0.3 g/L (equals≈2.1 mmol/L), 0.5 g/L (equals≈3.5 mmol/L) and 3 g/L (equals≈20.8 mmol/L) of sodium benzoate in deionized water. Results are shown in Table 1 of the results section below.

### Testing of Cleaned, Rinsed, Surface-Treated and Further Coated Substrates

### Preparation of Specimens

Hot dip galvanized steel (HDG) panels and cold rolled steel panels (CRS) as indicated in Table 2 below were dip-cleaned with an alkaline cleaner (containing 20 g/L GC 5345 and 3 g/L GBA H 7406; both commercially available from Chemetall GmbH) for 180 s at a temperature of 60° C., followed by a tap water rinse (first rinse) for 30 s.

The first rinse is followed by a second rinse as indicated in Table 2. The second rinse being performed with deionized water (DI water) only (Comparative Examples*) or deionized water supplemented with 0.5 g/L sodium benzoate (Inventive) for 30 s.

Subsequently to the second rinse, the substrates (panel) of Examples 2a*, 2b*, 3a*, 3b*, 5a*, 5b*, 6a and 6b were exposed to high humidity according to above Procedure 2 Step (d) followed by drying according to Procedure 2 Step (e).

Subsequently to the second rinse with or without high humidity treatment, the panels were dip-treated in different chemical pre-treatment bathes as indicated in Table 2 at a temperature of 60° C. for 180 s. In Examples 1a*, 1b*, 2a*, 2b*, 3a and 3b the chemical pre-treatment was carried out with OS 9832; in Examples 4a*, 4b*, 5a*, 5b*, 6a and 6b the chemical pre-treatment was carried out with GB X 2025/2.

After the chemical pre-treatment all samples were rinsed with deionized water for 30 s and dried afterwards at a temperature of 120° C. for 30 s.

The thus completed pre-treatment was followed by coating the panels with an electrodeposition coating composition (BASF Cathoguard® 800) which was cured at 175° C. for 20 min resulting in a dry layer thickness of the electrodeposition coating layer being approx. 20±2 μm.

The thus resulting specimens were test in a natural salt spray test, VDA new climate change test, and climate change test PV1210, which are describe in detail in the following.

### Neutral Salt Spray Test (NSS Test)

The NSS test is used for determining the corrosion resistance of a coating on a substrate. In accordance with DIN EN ISO 9227 NSS (date: Sep. 1, 2012), the NSS test is carried out for an electrically conductive substrate coated with an inventive coating composition or with a comparative coating composition. In this test, the samples under analysis are in a chamber in which there is continuous misting with a 5% strength common salt solution at a temperature of 35° C. over a duration of 1008 hours at a controlled pH in the range from 6.5 to 7.2. The mist deposits on the samples under analysis, covering them with a corrosive film of salt water. If, still prior to NSS test to DIN EN ISO 9227 NSS, the coating on the samples under analysis is scored down to the substrate with a blade incision (Scratch Master 1 mm blade, 75 μm), the samples can be investigated for their level of under-film corrosion (undermining) to DIN EN ISO 4628-8 (date: Mar. 1, 2013), since the substrate corrodes along the score line during the DIN EN ISO 9227 NSS test. This investigation takes place after the NSS test has been carried out for a duration of 1008 hours. As a result of the progressive process of corrosion, the coating is undermined to a greater or lesser extent during the test. The extent of undermining in [mm] is a measure of the resistance of the coating to corrosion. The values are average values of 3 panels. The results are shown in Table 2.

### VDA New Climate Change Test (VDA New Test; VDA 233-102 Test)

The VDA New test is used for determining the corrosion resistance of a coating on a substrate. In accordance with DIN 55635 (May 2019), the VDA new test is carried out for an electrically conductive substrate coated with an inventive coating composition or with a comparative coating composition. The alternating climate test here is carried out in 6 cycles. One cycle here consists of a total of 168 hours (1 week) and encompasses three phases that represent 24 hours of the cycle time. The three phases are characterized as follows.
a) Salt spray phase (A): 3 hours of salt spray mist (1% NaCl solution; 35° C.; 100% relative humidity)
b) Observation phase (B): 3 hours 25° C., 70% relative humidity
c) Low temperature phase (C): 1 hour −2.5° C.; 6 hours −15° C. and 1 hour −2° C.; no regulation of the relative humidity

The test cycle is formed by the combination of the three phases in the following order: B A C A B B A

The respective coating on the samples under investigation is scored down to the substrate with a bladed incision prior to the implementation of the alternating climate test, thus allowing the samples to be investigated for their level of under-film corrosion (undermining) to DIN EN ISO 4628-8 (date: Mar. 1, 2013), since the substrate corrodes along the score line during the performance of the alternating climate test. As a result of the progressive process of corrosion, the coating is undermined to a greater or lesser extent during the test. The degree of undermining in [mm] is a measure of the resistance of the coating to corrosion. The average undermining level stated in the results later on below represents the average value of the individual values from three to five different panels assessed, with each individual value for a panel in turn being an average value of the undermining levels at 11 measurement points on the panel. The results are shown in Table 2.

### Climate Change Test PV1210 (PV1210 Test)

This climate change test is used to determine the corrosion resistance of a coating on a substrate. The climate change test is carried out in 30 so-called cycles. Prior to the PV1210 test, the coating of the specimens to be tested is scored down to the substrate with a knife cut (Scratch Master 1 mm blade, 75 μm) before the climate change test is performed, the specimens can be tested for their degree of under-film corrosion in accordance with DIN EN ISO 4628-8 (03-2013), since the substrate corrodes along the scoring line during the climate change test. As corrosion progresses, the coating is more or less infiltrated during the test. The degree of undermining in [mm] is a measure of the resistance of the coating. The values are average values of 3 panels.

This alternating climate test PV 1210 is used for determining the corrosion resistance of a coating on a substrate. The alternating climate test is carried out for corresponding coated electrically conductive substrates composed of hot-dip-galvanized steel (HDG). The alternating climate test here is carried out in 30 cycles. One cycle (24 hours) here consists of 4 hours of salt spray mist testing as per DIN EN ISO 9227 NSS (June 2017), 4 hours of storage, including cooling as per DIN EN ISO 6270-2 of September 2005 (AHT method) and 16 hours of storage, including heating, as per DIN EN ISO 6270-2 of September 2005, AHT method, at 40±3° C. and at atmospheric humidity of 100%. After each 5 cycles there is a pause of 48 hours, including cooling, as per DIN EN ISO 6270-2 of September 2005, AHT method. 30 cycles therefore correspond to a total duration of 42 days.

The respective coating on the samples under investigation is scored down to the substrate with a bladed incision prior to the implementation of the alternating climate test, thus allowing the samples to be investigated for their level of under-film corrosion (undermining) to DIN EN ISO 4628-8 (date: Mar. 1, 2013), since the substrate corrodes along the score line during the performance of the alternating climate test. As a result of the progressive process of corrosion, the coating is undermined to a greater or lesser extent during the test. The degree of undermining in [mm] is a measure of the resistance of the coating to corrosion. The average undermining level stated in the results later on below represents the average value of the individual values from three to five different panels assessed, with each individual value for a panel in turn being an average value of the undermining levels at 11 measurement points on the panel. The results are shown in Table 2.

### Results

The results of the FRF testing were evaluated visually as described above and shown in the following Table 1.

TABLE 1

| | Concentration of sodium benzoate in deionized | | | | |
|---|---|---|---|---|---|
| | water used in the second rinse [g/L] | | | | |
| FRF test | 0.1 | 0.2 | 0.3 | 0.5 | 3.0 |
| Procedure 1 | no | inhibition | inhibition | inhibition | inhibition |
| | inhibition | | | | |
| Procedure 2 | inhibition | inhibition | inhibition | inhibition | inhibition |

At a concentration of 0.1 g/L (equals≈0.7 mmol/L) of sodium benzoate in deionized water, an inhibition according to FRF test Procedure 2 was already observed. At a concentration of 0.2 g/L (equals≈1.4 mmol/L) of sodium benzoate in deionized water, an inhibition according to FRF test procedures 1 and 2 was observed. The tests were carried out up to a concentration of 3.0 g/L (equals≈20.8 mmol/L) of sodium benzoate in deionized water without a detrimental effect. Thus, even much higher concentrations of the corrosion inhibitor are acceptable. Such concentrations even higher concentrations are limited by process economy and the risk of an excessive drag-over of sodium benzoate into the next steps, which might influence the performance of the subsequent step.

TABLE 2

| | | | | Chemical Pre- | | | VDA |
|---|---|---|---|---|---|---|---|
| Ex. | Substrate | Second Rinse | Flash Rust Simulation | Treatment | NSS | PV1210 | 233-102 |
| 1a* | HDG | DI water | no | OS 9832² | | | 0.7 |
| 1b* | CRS | | | | 1.1 | 0.6 | 2.4 |
| 2a* | HDG | DI water | exposure to high humidity¹ | OS 9832² | | | 1.9 |
| 2b* | CRS | | | | 3.2 | 2.5 | 4.7 |
| 3a | HDG | DI water + 0.5 g/L | exposure to high humidity¹ | OS 9832² | | | 0.6 |
| 3b | CRS | sodium benzoate | | | 1.3 | 0.8 | 2.1 |
| 4a* | HDG | DI water | no | GB X 2025/2³ | | | 0.6 |
| 4b* | CRS | | | | 1.1 | 0.9 | 2.4 |
| 5a* | HDG | DI water | exposure to high humidity¹ | GB X 2025/2³ | | | 1.7 |
| 5b* | CRS | | | | 3.0 | 2.7 | 4.5 |
| 6a | HDG | DI water + 0.5 g/L | exposure to high humidity¹ | GB X 2025/2³ | | | 0.5 |
| 6b | CRS | sodium benzoate | | | 1.3 | 0.8 | 2.5 |

*Comparative Examples
¹Procedure 2 steps (d) and (e)
²OS 9832: Oxsilan ® 9832, organosilane-based thin-film forming composition commercially available from Chemetall GmbH
³GB × 2025/2: Gardobond ® GB × 2025/2 polymer-based passivation composition containing, commercially available from Chemetall GmbH

In Comparative Examples 1a*/1b* no corrosion inhibitor was use, however no exposure to high humidity (flash rust condition simulation) was carried out either. Thus, the results in the corrosion test were good. To the contrary, in Comparative Examples 2a*/2b* the same procedure was carried out, however with flash rust condition simulation and rather bad corrosion testing results were observed. In inventive Examples 3a/3b Comparative Examples 2a*/2b* were repeated, however, with the difference that in the second rinse 0.5 g/L, i.e., approx. 3.5 mmol/L of sodium benzoate were contained. The addition of the sodium benzoate prevented the detrimental effects of the flash rust simulation test.

Comparing inventive Example 3a with comparative Example 2a* clearly shows that the presence of 0.5 g/L, i.e., approx. 3.5 mmol/L of sodium benzoate in the second rinsing composition significantly improves the corrosion resistance of the thus treated and OS 9832 pre-treated hot dip galvanized steel panel (HDG panel) in the VDA 233-102 test, the degree of undermining being just 0.6 mm for the inventive sample 3a compared to 1.9 mm of the comparative Example 2a*.

Comparing inventive Example 3b with comparative Example 2b* clearly shows that the presence of 0.5 g/L, i.e., approx. 3.5 mmol/L of sodium benzoate in the second rinsing composition also significantly improves the corrosion resistance of the thus treated and OS 9832 pre-treated cold rolled steel panels (CRS panels). In the NSS test, the degree of undermining being just 1.3 mm for the inventive sample 3b compared to 3.2 mm of the comparative Example 2b*, in the PV1210 test, the degree of undermining being just 0.8 mm for the inventive sample 3b compared to 2.5 mm of the comparative Example 2b* and in the VDA 233-102 test, the degree of undermining being just 2.1 mm for the inventive sample 3b compared to 4.7 mm of the comparative Example 2b*.

Furthermore, inventive Example 3b and comparative Examples 2b* were exposed to high humidity. While for inventive Example 3b there was no visible flash-rust formation, comparative Examples 2b* showed strong flash rust formation.

Even more impressive are the results, when comparing inventive Examples 6a and 6b with comparative Examples 5a* and 5b*, particularly comparing inventive Example 6b with comparative Example 5b*.

Comparing inventive Example 6a with comparative Example 5a* clearly shows that the presence of 0.5 g/L, i.e., approx. 3.5 mmol/L of sodium benzoate in the second rinsing composition significantly improves the corrosion resistance of the thus treated and GB X 2025/2 pre-treated hot dip galvanized steel panel (HDG panel) in the VDA 233-102 test, the degree of undermining being just 0.5 mm for the inventive sample 6a compared to 1.7 mm of the comparative Example 5a*.

Comparing inventive Example 6b with comparative Example 5b* clearly shows that the presence of 0.5 g/L, i.e., approx. 3.5 mmol/L of sodium benzoate in the second rinsing composition also significantly improves the corrosion resistance of the thus treated and GB X 2025/2 pre-treated cold rolled steel panels (CRS panels. In the NSS test, the degree of undermining being just 1.3 mm for the inventive sample 6b compared to 3.0 mm of the comparative Example 5b*, in the PV1210 test, the degree of undermining being just 0.8 mm for the inventive sample 6b compared to 2.7 mm of the comparative Example 5b* and in the VDA 233-102 test, the degree of undermining being just 2.5 mm for the inventive sample 6b compared to 4.5 mm of the comparative Example 5b*.

Although the specimen use in inventive Example 6b was exposed to high humidity, no visible flash rust was observed, while the comparative Example 5b*, which exposed to high humidity, showed strong flash-rust formation.

1. A method of pre-treating a metallic substrate, the method comprising
i. one or more pre-treating steps selected from the groups consisting of cleaning steps, wherein at least part of the surface of the metallic substrate is contacted with one or more aqueous cleaning compositions, to obtain a cleaned metallic substrate; and/or
ii. one or more chemical pre-treatment steps selected from the group consisting of conversion treating steps, passivation treating steps and thin-layer forming steps, wherein at least part of the surface of a metallic substrate is contacted with one or more chemical pre-treatment compositions selected from the group consisting of conversion treatment compositions, passivation treatment compositions and thin-layer forming compositions to obtain a chemically pre-treated substrate;
wherein i. and/or ii. are followed by one or more rinsing steps, characterized in that at least one rinsing composition is used, which comprises an amount of water in the range from 97 wt.-% to 99.99 wt.-% and an amount of 0.8 to 200 mmol/L of the composition of one or more compounds of formula (I) 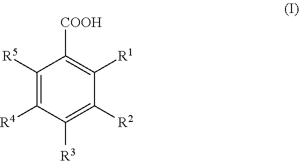
the COOH group of which can be fully or partially neutralized and wherein one or more of residues R¹, R², R³, R⁴ and R⁵ are independently selected from each other from the group consisting of H, hydroxy groups and alkyl groups.

2. The method of pre-treating a metallic substrate according to claim 1, comprising
i. one or more cleaning steps; followed by
ii. one or more chemical pre-treatment steps,
wherein i. and ii. are followed by one or more rinsing steps.

3. The method of pre-treating a metallic substrate according to claim 1, comprising
i. one or more cleaning steps;
followed by one or more activation steps, followed by
ii. one or more chemical pre-treatment steps selected from the group consisting of phosphate conversion treating steps, wherein at least part of the surface of a metallic substrate is contacted with one or more chemical pre-treatment compositions selected from phosphate conversion treatment compositions,
wherein i. and ii. are followed by one or more rinsing steps.

4. The method of pre-treating a metallic substrate according to claim 1, comprising
i. one or more cleaning steps; directly followed by
ii. one or more phosphate-free chemical pre-treatment steps,
wherein i. and ii. are followed by one or more rinsing steps.

5. The method of pre-treating a metallic substrate according to claim 1, wherein the one or more compounds of formula (I) are comprised in at least one of the rinsing compositions.

6. The method of pre-treating a metallic substrate according to claim 1, wherein the one or more compounds of formula (I) are present in at least one composition selected from the group consisting of cleaning compositions, rinsing compositions and chemical pre-treatment compositions in an amount from 1.0 to 150 mmol per liter of the respective composition.

7. The method of pre-treating a metallic substrate according to claim 1, wherein in the one or more compounds of formula (I) residues R¹, R², R³, R⁴ and R⁵ are H; and the COOH group is fully or partially neutralized in form of its alkali metal salts, ammonium salts and/or quaternary ammonium salts.

8. The method of pre-treating a metallic substrate according to claim 1, where the one or more rinsing steps are carried out with one or more rinsing compositions possessing a pH value in the range from 6 to 10.

9. The method of pre-treating a metallic substrate according to claim 1, wherein the chemical pre-treatment composition is selected from the group consisting of:
a. layer-forming phosphate conversion treatment compositions and/or non-layer-forming phosphate conversion treatment compositions;
iv.
b. organosilane based thin-film forming compositions containing at least one organosilane and/or its hydrolysis products and/or its condensation products;
c. passivating compositions containing at least one compound selected from the group consisting of zirconium compounds, titanium compounds and hafnium compounds;
d. passivating and thin-film forming compositions containing at least one compound selected from the group consisting of zirconium compounds, titanium compounds and hafnium compounds and containing at least one organosilane and/or its hydrolysis products and/or its condensation products;
e. passivating compositions containing at least one compound selected from the group consisting of zirconium compounds, titanium compounds and hafnium compounds and containing one or more polymers selected from the group consisting of poly(vinyl phenol)s, poly(meth)acrylic acid, (meth)acrylic acid copolymers, maleic acid copolymers, phosphonic acid copolymers, particularly (phosphonic acid-acrylic acid) copolymers, polyvinyl pyrrolidone and vinyl pyrrolidone copolymers, vinyl acetate copolymers, particularly (vinyl alcohol-vinyl acetate) copolymers, ethoxylated polymers, polyethylene glycol and copolymers, and linear or branched poly(ethylene imines).

10. The method of pre-treating a metallic substrate according to claim 1, characterized in that contacting the metallic substrate with one or more chemical pre-treatment compositions is carried out by spray application and/or dip application for a contacting time from 15 seconds to 8 min, and a contacting temperature in the range from 10 to 60° C.

11. A metallic substrate obtained according to the method according to claim 1.

12. A method of coating a metallic substrate, wherein the metallic substrate is treated by a method of pre-treating a metallic substrate according to claim 1, and
wherein after the last rinsing step
iii. one or more coating compositions selected from the group consisting of solid coating compositions and liquid coating compositions are applied to form one or more coating layers, each of the one or more coating layers being cured or not cured after application; and
iv. curing any one or more coating layers applied in step iii. which is or are not cured in step iii.

13. The method of coating a metallic substrate according to claim 12, wherein in step iii. the one or more coating compositions are selected from the group consisting of powder coating compositions, aqueous one-pack or two-pack compositions, solvent borne one-pack or two-pack compositions and radiation curable coating compositions.

14. A coated metallic substrate obtained according to claim 12.

15. A method of using an aqueous composition containing 97 to 99.9 wt.-% of water and an amount of 0.8 to 200 mmol/L of the composition of one or more compounds of formula (I) 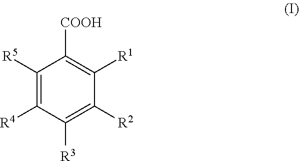
the COOH group of which can be fully or partially neutralized and wherein one or more of residues R¹, R², R³, R⁴ and R⁵ are independently selected from each other from the group consisting of H, hydroxy groups and alkyl groups, the method comprising using the aqueous composition in pre-treating a metallic substrate, the pre-treating comprising at least one of a cleaning step and a chemical pre-treatment step; and in addition, at least one rinsing step.

16. The method of use according to claim 15, wherein the method prevents or inhibits flash rust formation on the metallic substrate.

17. The method of pre-treating a metallic substrate according to claim 1, wherein the layer-forming phosphate conversion treatment compositions and/or non-layer-forming phosphate conversion treatment compositions are selected from the group consisting of:
i. Ni-containing and Ni-free zinc phosphating compositions and trication phosphating compositions,
ii. compositions forming amorphous phosphate conversion coatings,
iii. phosphate conversion treatment compositions containing zinc ions and at least one of manganese ions and nickel ions including Ti/Zn based activation and optional zirconium-based passivation; and
iv. compositions forming amorphous iron phosphate conversion coatings.
